(19) United States
(12) Patent Application Publication
(10) Pub. No.: US 2002/0002705 A1
(43) Pub. Date: Jan. 3, 2002

(54) Computer profile update system

(75) Inventors: Nigel J. Byrnes, Reigate (GB); David C. Yule, Taipei (TW)

Correspondence Address: Corporate Paten Counsel, U.S. Philips Corporation, 580 White Plains Road, Tarrytown, NY, 10591, US

(73) Assignee: U.S. PHILIPS CORPORATION

(21) Appl. No.: 09/861,936

(22) Filed: May 21, 2001

(30) Foreign Application Priority Data
Jun. 12, 2000 (GB) 0014325.5

(51) Int. Cl. H04N 7/16; H04H 9/00

(52) U.S. Cl. 725/14

(57) ABSTRACT

A computer profile update system comprises an update control computer (30) arranged to communicate with a user computer (10), a profile being held in a memory (15) which is associated with the user computer (10) and/or with the user. The update control computer (30) is configured to communicate suggested profile updates to the user computer (10) and, if the suggested profile updates are accepted, corresponding updates are made to the profile in the memory (15).

The present invention relates to a system allowing updating of profiles on computer devices. In particular, the present invention is particularly suitable for updating user profiles on portable computerised devices such as mobile telephones.

Increasingly, computers and computer based services store information about users. A home computer may store personal information about its user owner, information on its own hardware and associated settings, information on installed software and its associated settings and preferences and also information on user interface settings that have been selected by the user. This information is held as a profile associated with the user and/or computer and is maintained to enable the user and computer to be able to receive information and access services that are relevant and appropriately formatted. To enable such personalisation, the information or service provider computers need to know about the user and his computer. When a user requests information or a service from the service provider, parts of the profile may be transmitted to the appropriate server which interprets the data and generates an appropriate response for the user. The World Wide Web commission (W3C) have published the document composite capability/preference profiles (CC/PP): a user side frame work for content negotiation which details such a system.

One rapidly developing area is mobile access to online services. Devices such as personal digital assistants and mobile phones are already available that can be used to access online information. The WAP forum has developed and published an open global wireless protocol specification based on existing Internet standards for wireless communication that allows mobile users with such mobile devices to easily access interactive information services and applications. However, in order to keep the cost and weight of the mobile devices down, they currently have limited processor and memory capabilities, small display screens and can only communicate at very limited speeds. As each type of mobile device is different in terms of its screen size, memory and processing capabilities, profiles are extremely important because they allow the interactive services such as WAP based Web Sites to adapt their output (for example change the complexity of the output display or change the size of the output display) to make it more suitable for the mobile device. In order to optimise performance of Web access and mobile device operation, the profile need not necessarily be help by the mobile device. Indeed, due to the extremely limited memory and storage capacity mobile devices profiles may be stored centrally in a profile database and supplied to the contents server by a WAP gateway as and when required instead of being stored locally on the device. However, this shifts the burden to the WAP gateway and, in this scenario, the mobile device must access the WAP gateway each time the user changes it's configuration. The most likely outcome of this is that the profile is distributed between a number of sites including the WAP gateway, the mobile device and possibly other sites.

However, while a user obviously wishes to retain full control over his profile, he may not be particularly familiar with all of its contents, in particular the more technical contents. Furthermore, the user may not have the time or the ability to update profile elements. In the event that the profile is distributed over a number of sites, this must be centrally managed to ensure the correct parts are properly updated.

According to a first aspect of the present invention, there is provided a computer profile update system comprising an update control computer arranged to communicate with a user computer, a profile being held in a memory which is associated with the user computer and/or with the user, the update control computer being configured to communicate suggested profile updates to the user computer, wherein if the suggested profile updates are accepted, corresponding updates are made to the profile in the memory.

In the system of the present invention, the user remains in control of the profile but is prompted and guided through the updating of the profile as and when it is required. In this manner, no technical or detailed knowledge is required of the user, nor does the user have to concern himself as to when updates are required. Optionally, technical details of updates may be omitted and the user may be notified only of the effect the update may have. In this way the non-technical user is still fully aware and in control of the effect of an update.

Examples of the present invention will now be described in detail with reference to the accompanying drawings, in which:

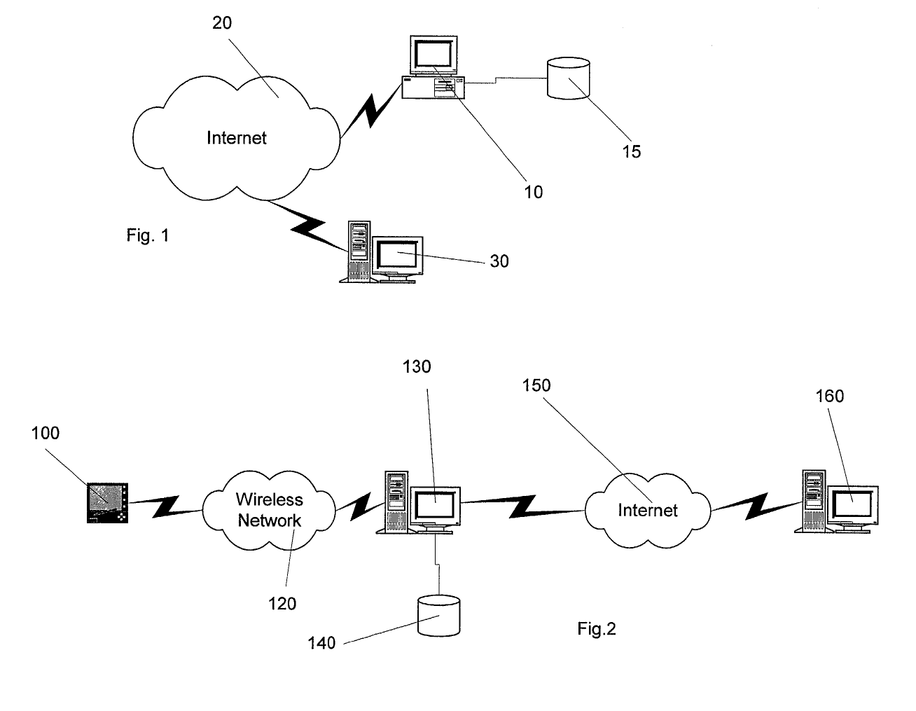

FIG. 1 is a schematic diagram of a computer system incorporating a profile updating system according to one aspect of the present invention;

FIG. 2 is a schematic diagram of a mobile communication system incorporating the profile updating system according to another aspect of the present invention; and,

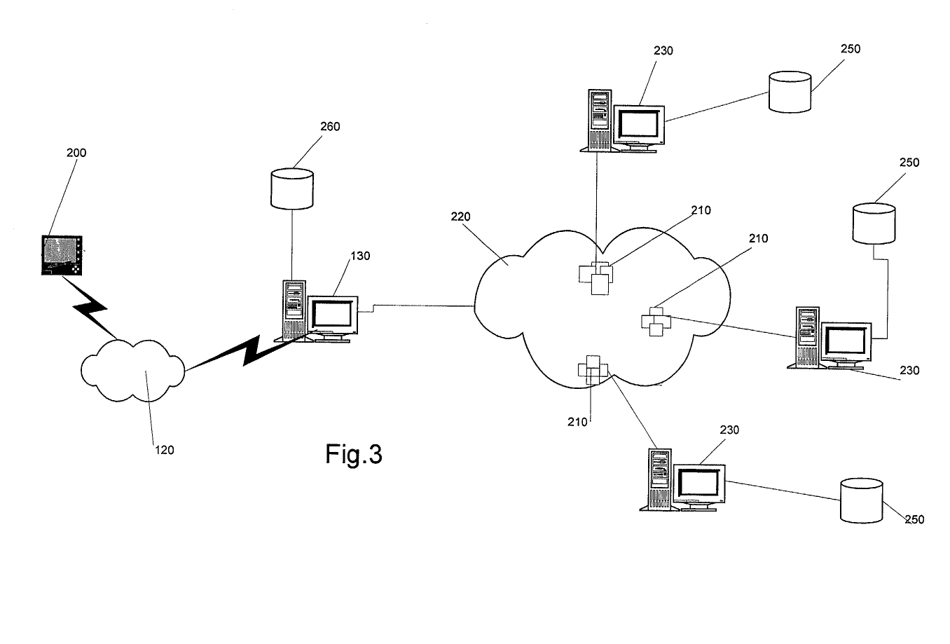

FIG. 3 is a schematic diagram of a mobile communication system incorporating the profile updating system according to another aspect of the present invention.

FIG. 1 is a schematic diagram of a computer system incorporating a profile updating system according to one aspect of the present invention. A user's computer 10 is connected to the Internet 20. The computer 10 includes a hard disk storage device 15 on which profiles on the user and his computer 10 are stored. Each time the user installs new software or hardware or changes the user interface, the profiles are updated by the computer.

An update control computer in the form of a profile server 30 is also connected to the Internet 20. As a new service comes on line or the user's circumstances change the profile must be updated. The profile server 30 generates a profile update made up of a number of suggested changes to elements within the profile. The profile update is communicated to the user's computer 10 over the Internet 20. Upon receipt, the user is notified that the profile requires updating and the suggested changes. The suggested changes notified to the user may optionally omit technical details and only describe the nature and/or effect of the change. If the user accepts the changes, they are applied to the appropriate profile in a memory, such as storage device 15. Otherwise, the profile update is discarded.

FIG. 2 is a schematic diagram of a mobile communication system incorporating the profile updating system according to another aspect of the present invention.

The mobile communication system includes a user computer in the form of a mobile device 100 in communication with a wireless network 120 (such as a digital cellular network). A WAP gateway 130 acting as an update control computer is also in communication with the wireless network 120 and a memory in the form of profile database 140. The WAP gateway 130 is also connected to the Internet 150. A content server 160 is also connected to the Internet 150.

When the mobile device 100 is requested to access the Internet 150 it communicates with the WAP gateway via the wireless network 120. The WAP gateway acts as an intermediary between the mobile device 100 and the Internet by accepting WAP Internet access requests from the mobile device 100, parsing the requests and submitting them to the appropriate content server 160 along with necessary data from the profile. The content server 160 processes the request and formats it in dependence on the data from the profile to produce a reply. When the reply is received from the content server 160, it is processed by the WAP gateway 130 and forwarded to the mobile device 100 for display.

A profile may need updating, for example, if a user takes his mobile device outside of the network he is subscribed to such that he will not be able to receive a cell broadcast. In this case, the profile should be updated so cell broadcast is inhibited. A profile may also need updating if more memory is added to a mobile device, a new operating system loaded, the user's details change or a new service requiring more information than is currently in the profile becomes available. A profile may also be updated by a content server or other external agency. For example, where the content server is a sports server and the user currently subscribes to football sports information that is normally retrieved once a week, when a major tournament such as the European or World cup is held, the sports server requests to update the server SO that information is retrieved every day. In each of these circumstances, the WAP gateway 130 generates a profile update message that includes the changes suggested to be made to the user's profile. The message is transmitted across the wireless network 120 to the mobile device 100 and the suggested changes are displayed to the user. Optionally, technical details of the suggested changes may be omitted and the user is only advised of their nature and/or effect. If the user chooses to accept the changes, the message is transmitted back to the WAP gateway 130 and the user's profile is updated in the records of the profile database 140 associated with the mobile device 100 and/or the user at the WAP gateway. Otherwise, the message is discarded and no changes are made.

FIG. 3 is a schematic diagram of a mobile communication system incorporating the profile updating system according to another aspect of the present invention.

Where the profile is distributed over a number of sites, once the update is accepted, the appropriate part of the profile is determined by the WAP gateway 130 and the update is then applied or transmitted for application.

The mobile communication system includes a user computer in the form of a personal data assistant 200 in communication with a wireless network 120. A WAP gateway 130 acting as an update control computer is also in communication with the wireless network 120. The WAP gateway 130 is also in communication with a number of websites 210 over the Internet 220 that are maintained by respective web servers 230. The PDA is registered with the web sites 210, as a result of which a profile is stored in a database 250 of the respective web server 230.

The WAP gateway 130 maintains an overall database 260 of the users and/or PDA devices profiles held by the respective web servers 230. Where the WAP server determines an update should be applied and the update is accepted by the user, the WAP server 130 communicates with the respective web servers 230 to arrange the update of the user and/or PDA profile in the database 250.

The above embodiments of the present invention have been concerned with profiles held by or on behalf of a user's computer that are used to customise received data so it can be properly displayed and processed by the user. However, profiles are also generated and stored, both on user's computers as cookies and on remote systems, that allow data and metadata on the user to be stored. These profiles allow user interfaces to be personalised, specific information targeted at users having common interests or for systems to learn about users and their needs so as to be able to predict information they require in future and offer it when it becomes available. Such profiles are in wide-scale use in Internet search engines, subscription services and the like. The present invention is equally applicable to these types of profiles. If the profile is stored on the user's computer then it could be modified in a manner similar to that described with reference to FIG. 1. Otherwise, where a profile is stored on a remote computer, such as an Internet search engine's WWW server, the profile could be modified in a manner similar to that described with reference to FIG. 2.

1. Computer profile update system comprising an update control computer arranged to communicate with a user computer, a profile being held in a memory which is associated with the user computer and/or with the user, the update control computer being configured to communicate suggested profile updates to the user computer, wherein if the suggested profile updates are accepted, corresponding updates are made to the profile in the memory.

2. A computer profile update system according to claim 1, in which the memory is connected to the user computer, wherein if the suggested profile updates are accepted, the user computer is arranged to make the corresponding updates to the profile in the memory.

3. A computer profile update system according to claim 1, in which the memory is connected to a remote computer arranged to communicate with the user computer, wherein if the suggested profile updates are accepted, the remote computer is instructed to make the corresponding updates to the profile in the memory.

4. A computer profile update system according to claim 1, in which the memory is distributed across a number of computers, wherein if the suggested profile updates are accepted, the update control computer is arranged to determine the memory of the computer or the computers to which the profile update should be applied and to apply or instruct the application of the updates to the memory or memories.

5. A computer profile update system according to claim 3, wherein the update control computer is the remote computer.

6. A computer profile update system according to claim 1, wherein the update control computer is a WAP gateway.

7. A computer profile update system according to claim 1, in which the user computer is configured to display details of received suggested profile updates and to accept inputs from a user as to acceptance of the suggested profile updates.

8. A computer profile update system according to claim 7, in which the user computer is configured not to display technical details of suggested profile updates.

9. A computer profile update system according to claim 7, in which the user computer is configured to display the nature and/or effect of the suggested profile updates.

10. A method of updating a computer profile associated with a user computer and/or a user comprising the steps of:
maintaining the profile in a memory associated with the user computer and/or with the user;
communicating suggested profile updates to the user computer;
updating the profile in the memory if the suggested profile updates are accepted.

11. A method according to claim 10, in which the memory is connected to a remote computer, the method further comprising the step of instructing the remote computer to make the corresponding updates to the profile in the memory if they are accepted.

12. A method according to claim 10, in which the memory is distributed across a number of computers, the method further comprising the step of determining the memory of the computer or computers to which the update should be applied and instructing the computer or computers to make the update.

13. A method according to claim 10, further comprising the step of displaying details of suggested profile updates to the user on the user computer and accepting inputs on the user computer regarding acceptance or rejection of the suggested profile updates.

14. A method according to claim 13, further comprising the step of not displaying technical details of suggested profile updates.

15. A method according to claim 13, further comprising the step of displaying data regarding the nature and/or affect of the suggested profile updates to the user on the user computer.

16. A computer readable storage medium, on which is stored a computer program of instructions for a general purpose computer for updating a computer profile associated with the computer and/or a user comprising, in combination:
means for enabling the computer to maintain the profile in a memory associated with the computer and/or with the user;
means for enabling the computer to receive suggested profile updates from a remote computer;
means for enabling the computer to update the profile in the memory if the suggested profile updates are accepted.

17. A program according to claim 16, in which the memory is connected to a remote computer, the computer program further comprising means for enabling the computer to instruct the remote computer to make the corresponding updates to the profile in the memory if they are accepted.

18. A program according to claim 16, in which the memory is distributed across a number of remote computers, the program further comprising means for enabling the computer to determine the memory of the remote computer or computers to which the update should be applied and means for enabling the computer to instruct the remote computer or computers to make the update.

19. A program according to claim 16, further comprising means for enabling the computer to display details of suggested profile updates to the user and means for enabling the computer to accept inputs on regarding acceptance or rejection of the suggested profile updates.

20. A program according to claim 19, further comprising means for enabling the computer to determine technical details of suggested profile updates and means for enabling the computer to prevent the display of determined technical details.

21. A program according to claim 19, further comprising means for enabling the computer to display data regarding the nature and/or affect of the suggested profile updates to the user.

22. A program storage device readable by a machine and encoding a program of instructions for executing the method steps of claim 10.
